(19) United States
(12) Patent Application Publication
(10) Pub. No.: US 2008/0019661 A1
(43) Pub. Date: Jan. 24, 2008

(54) Producing output video from multiple media sources including multiple video sources

(76) Inventors: Pere Obrador, Palo Alto, CA (US); Tong Zhang, Palo Alto, CA (US); Sahra Reza Girshick, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/488,556

(22) Filed: Jul. 18, 2006

(51) Int. Cl. H04N 5/93

(52) U.S. Cl. 386/52

(57) ABSTRACT

Systems and methods of producing an output video are described. In one approach, respective frame scores are assigned to video frames of input videos containing respective sequences of video frames. Shots of consecutive video frames are selected from the input videos based at least in part on the assigned frame scores. An output video is generated from the selected shots.

### BACKGROUND

Individuals and organizations are rapidly accumulating large collections of digital image content, including visual media content (e.g., still images and videos) and audio media content (e.g., music and voice recordings). As these collections grow in number and diversity, individuals and organizations increasingly will require systems and methods for organizing and presenting the digital content in their collections. To meet this need, a variety of different systems and methods for organizing and presenting digital image content have been proposed.

For example, some digital image albuming systems provide tools for manually organizing a collection of images and laying out these images on one or more pages. Other digital image albuming systems automatically organize digital images into album pages in accordance with dates and times specified in the metadata associated with the images. Storyboard summarization has been developed to enable full-motion video content to be browsed. In accordance with this technique, video information is condensed into meaningful representative snapshots and corresponding audio content. Content-based video summarization techniques also have been proposed. In these techniques, a long video sequence typically is classified into story units based on video content.

Due to the pervasiveness of digital cameras, the happenings of many events (e.g., family gatherings for birthdays, weddings, and holidays) oftentimes are recorded by multiple cameras. Most of this content, however, typically remains stored on tapes and computer hard drives in an unedited and difficult to watch raw form. If such content is edited at all, the portions that are recorded by different cameras typically are processed individually into respective media presentations (e.g., separate home movies or separate photo albums).

Existing manual video editing systems provide tools that enable a user to combine the various media contents that were captured during a particular event into a single video production. Most manual video editing systems, however, require a substantial investment of money, time, and effort before they can be used to edit raw video content. Even after a user has become proficient at using a manual video editing system, the process of editing raw video data typically is time-consuming and labor-intensive. Although some approaches for automatically editing video content have been proposed, these approaches typically cannot produce high-quality edited video from raw video data. In addition, these automatic video editing approaches are not capable of combining contemporaneous content from multiple media sources.

What are needed are methods and systems that are capable of automatically producing high quality edited video from contemporaneous media content obtained from multiple media sources including multiple video sources.

### SUMMARY

The invention features methods and systems of producing an output video. In accordance with these inventive methods and systems, respective frame scores are assigned to video frames of input videos containing respective sequences of video frames. Shots of consecutive video frames are selected from the input videos based at least in part on the assigned frame scores. An output video is generated from the selected shots.

Other features and advantages of the invention will become apparent from the following description, including the drawings and the claims.

### DESCRIPTION OF DRAWINGS

FIG. 1 is a block diagram of an embodiment of a video production system.

FIG. 2 is a flow diagram of an embodiment of a video production method.

FIG. 3 is a block diagram of an embodiment of a video frame scoring module.

FIG. 4 is a flow diagram of an embodiment of a video frame scoring method.

FIG. 5 is a block diagram of an embodiment of a frame characterization module.

FIG. 6 is a flow diagram of an embodiment of a method of determining image quality scores for a video frame.

FIG. 7A shows an exemplary video frame.

FIG. 7B shows an exemplary segmentation of the video frame of FIG. 7A into sections.

FIG. 8 is a flow diagram of an embodiment of a method of determining camera motion parameter values for a video frame.

FIG. 9 is a block diagram of an embodiment of shot selection module.

FIG. 10 is a flow diagram of an embodiment of a method of selecting shots from an input video.

FIG. 11A shows a frame score threshold superimposed on an exemplary graph of frame scores plotted as a function of frame number.

FIG. 11B is a graph of the frame scores in the graph shown in FIG. 11A that exceed the frame score threshold plotted as a function of frame number.

FIG. 12 is a devised set of segments of consecutive video frames identified based at least in part on the thresholding of the frame scores shown in FIGS. 11A and 11B.

FIG. 13 is a devised graph of motion quality scores indicating whether or not the motion quality parameters of the corresponding video frame meet a motion quality predicate.

FIG. 14 is a devised graph of candidate shots of consecutive video frames selected from the identified segments shown in FIG. 12 and meeting the motion quality predicate as shown in FIG. 13.

FIG. 15 is a devised graph of shots selected from two input videos plotted as a function of capture time.

FIG. 16 is a block diagram of an embodiment of a video production system.

FIG. 17 is a devised graph of the shots shown in FIG. 15 along with two exemplary sets of still images plotted as a function of capture time.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale. Elements shown with dashed lines are optional elements in the illustrated embodiments incorporating such elements.

### I. INTRODUCTION

### A. Exemplary Embodiment of a Video Production System

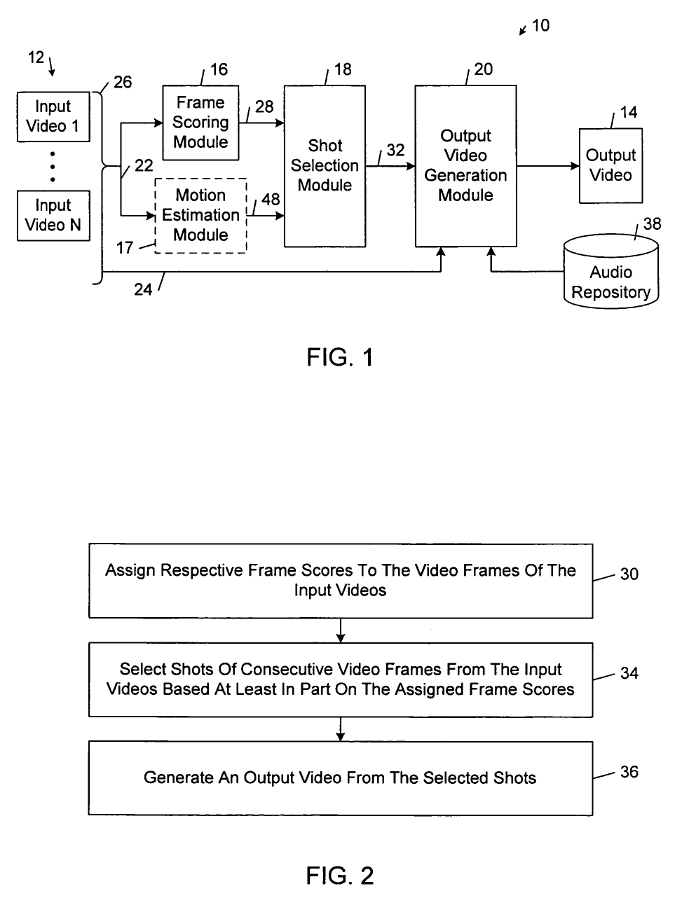

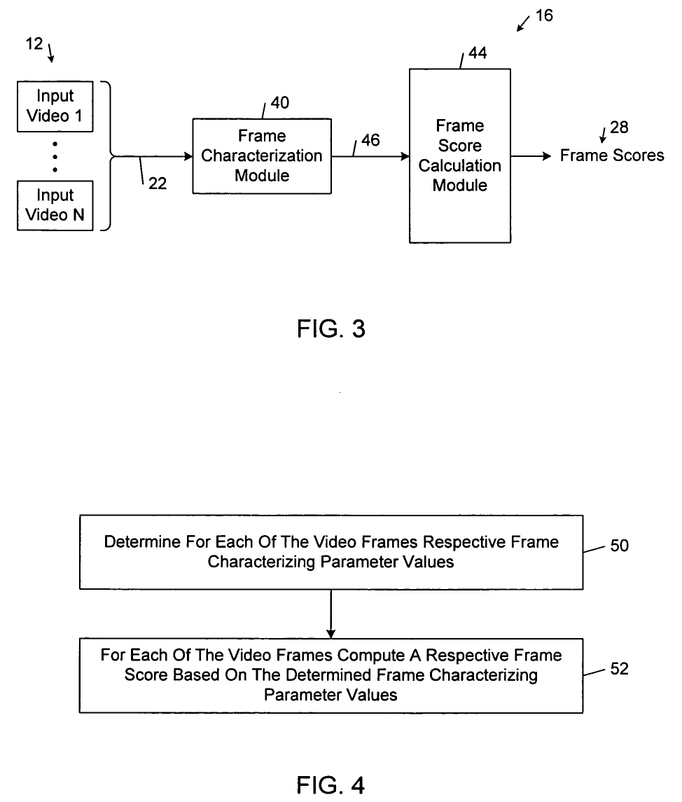

FIG. 1 shows an embodiment of a video production system 10 that is capable of automatically producing high quality edited video from contemporaneous media content obtained from multiple media sources, including multiple input videos 12 (i.e., Input Video 1, . . . , Input Video N, where N has an integer value greater than one). As explained in detail below, the video production system 10 processes the input videos 12 in accordance with filmmaking principles to automatically produce an output video 14 that contains a high quality video summary of the input videos 12 (and other media content, if desired). The video production system 10 includes a frame scoring module 16, an optional motion estimation module 17, a shot selection module 18, and an output video generation module 20.

In general, each of the input videos 12 includes a respective sequence of video frames 22 and audio data 24. The video production system 10 may receive the respective video frames 22 and the audio data 24 as separate data signals or as single multiplex video data signals 26, as shown in FIG. 1. When the input video data is received as single multiplex signals 26, the video production system 10 separates the video frames 22 and the audio data 24 from each of the single multiplex video data signals 26 using, for example, a demultiplexer (not shown), which passes the video frames 22 to the frame scoring module 16 and passes the audio data 24 to the output video generation module 20. When the video frames 22 and the audio data 24 are received as separate signals, the video production system 10 passes the video frames 22 directly to the frame scoring module 16 and passes the audio data 24 directly to the output video generation module 20.

The video production system 10 may be used in a wide variety of applications, including video recording devices (e.g., VCRs and DVRs), video editing devices, and media asset organization and retrieval systems. In general, the video production system 10 (including the frame scoring module 16, the optional motion estimation module 17, the shot selection module 18, and the output video generation module 18) is not limited to any particular hardware or software configuration, but rather it may be implemented in any computing or processing environment, including in digital electronic circuitry or in computer hardware, firmware, device driver, or software. For example, in some implementations, the video production system 10 may be embedded in the hardware of any one of a wide variety of electronic devices, including desktop and workstation computers, video recording devices (e.g., VCRs and DVRs), and digital camera devices. In some implementations, computer process instructions for implementing the video production system 10 and the data it generates are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable hard disks, magneto-optical disks, and CD-ROM.

### B. Exemplary Embodiment of a Video Production Method

FIG. 2 shows an embodiment of a method by which the video production system 10 generates the output video 14 from the input videos 12.

In accordance with this method, the frame scoring module 16 assigns respective frame scores 28 to the video frames 22 of the input videos 12 (FIG. 2, block 30). As explained in detail below, the frame scoring module 16 calculates the frame scores 28 from various frame characterizing parameter values that are extracted from the video frames 22. The frame score 28 typically is a weighted quality metric that assigns to each of the video frames 22 a quality number as a function of an image analysis heuristic. In general, the weighted quality metric may be any value, parameter, feature, or characteristic that is a measure of the quality of the image content of a video frame. In some implementations, the weighted quality metric attempts to measure the intrinsic quality of one or more visual features of the image content of the video frames 22 (e.g., color, brightness, contrast, focus, exposure, and number of faces or other objects in each video frame). In other implementations, the weighted quality metric attempts to measure the meaningfulness or significance of a video frame to the user. The weighted quality metric provides a scale by which to distinguish “better” video frames (e.g., video frames that have a higher visual quality are likely to contain image content having the most meaning, significance and interest to the user) from the other video frames.

The motion estimation module 17 determines for each of the video frames 22 respective camera motion parameter values 48. The motion estimation module 17 derives the camera motion parameter values 48 from the video frames 22. Exemplary types of motion parameter values include zoom rate and pan rate.

The shot selection module 18 selects shots 32 of consecutive video frames from the input videos 12 based at least in part on the assigned frame scores 28 (FIG. 2, block 34). As explained in detail below, the shot selection module 18 selects the shots 32 based on the frame scores 28, user-specified preferences, and filmmaking rules. The shot selection module 18 selects a set of candidate shots from each of the input videos 12. The shot selection module 18 then chooses a final selection 32 of shots from the candidate shots. In this process, the shot selection module 18 determines when ones of the candidate shots overlap temporally and selects the overlapping portion of the candidate shot that is highest in frame score as the final selected shot.

The output video generation module 20 generates the output video 14 from the selected shots 32 (FIG. 2, block 36). The selected shots 32 typically are incorporated into the output video 14 in chronological order with one or more transitions (e.g., fade out, fade in, and dissolves) that connect adjacent ones of the shots. The output video generation module 20 may incorporate an audio track into the output video 14. The audio track may contain selections from one or more audio sources, including the audio data 24 and music and other audio content selected from an audio repository 38 (see FIG. 1).

### II. EXEMPLARY COMPONENTS OF THE VIDEO PRODUCTION SYSTEM

### A. Exemplary Embodiments of the Frame Scoring Module

### 1. Overview

As explained in detail below, the frame scoring module 16 processes each of the input videos 12 in accordance with filmmaking principles to automatically produce a respective frame score 28 for each of the video frames 22 of the input videos 12. The frame scoring module 16 includes a frame characterization module 40, and a frame score calculation module 44.

Before the frame scoring module 16 assigns scores to the video frames 22, the video frames 22 of the input videos 12 typically are color-corrected. In general, any type of color correction method that equalizes the colors of the video frames 12 may be used. In some embodiments, the video frames are color-corrected in accordance with a gray world color correction process, which assumes that the average color in each frame is gray. In other embodiments, the video frames 12 are color-corrected in accordance with a white patch approach, which assumes that the maximum value of each channel is white.

FIG. 4 shows an embodiment of a method by which the frame scoring module 16 calculates the frame scores 28.

In accordance with this method, the frame characterization module 40 determines for each of the video frames 22 respective frame characterizing parameter values 46 (FIG. 4, block 50).

The frame characterization module 40 derives the frame characterizing parameter values from the video frames 22. Exemplary types of frame characterizing parameters include parameters relating to sharpness, contrast, saturation, and exposure. In some embodiments, the frame characterization module 40 also derives from the video frames 22 one or more facial parameter values, such as the number, location, and size of facial regions that are detected in each of the video frames 22.

The frame score calculation module 44 computes for each of the video frames 22 a respective frame score 28 based on the determined frame characterizing parameter values 46 (FIG. 4, block 52).

### 2. Exemplary Embodiments of the Frame Characterization Module

### a. Overview

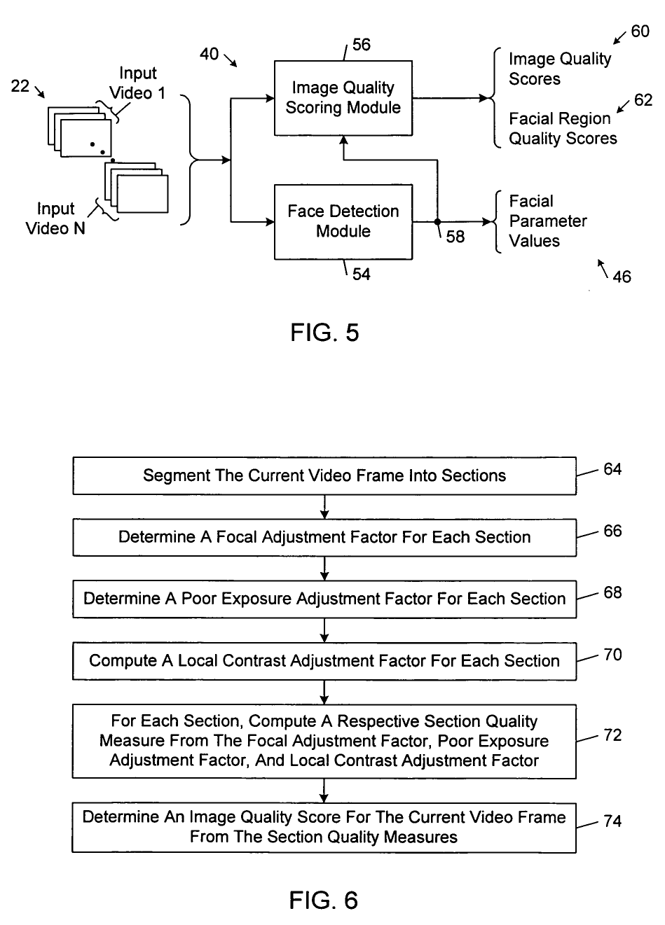

FIG. 5 shows an embodiment of the frame characterization module 40 that includes a face detection module 54 and an image quality scoring module 56.

The face detection module 54 detects faces in each of the video frames 22 and outputs one or more facial parameter values 58. Exemplary types of facial parameter values 58 include the number of faces, the locations of facial bounding boxes encompassing some or all portions of the detected faces, and the sizes of the facial bounding boxes. In some implementations, the facial bounding box corresponds to a rectangle that includes the eyes, nose, mouth but not the entire forehead or chin or top of head of a detected face. The face detection module 54 passes the facial parameter values 58 to the image quality scoring module 56 and the frame score calculation module 44.

The image quality scoring module 56 generates one or more image quality scores 60 and facial region quality scores 62. Each of the image quality scores 60 is indicative of the overall quality of a respective one of the video frames 22. Each of the facial region quality scores 62 is indicative of the quality of a respective one of the facial bounding boxes. The image quality scoring module 56 passes the image quality scores 60 to the frame score calculation module 44.

### b. Detecting Faces in Video Frames

In general, the face detection module 54 may detect faces in each of the video frames 22 and compute the one or more facial parameter values 58 in accordance with any of a wide variety of face detection methods.

For example, in some embodiments, the face detection module 54 is implemented in accordance with the object detection approach that is described in U.S. Patent Application Publication No. 2002/0102024. In these embodiments, the face detection module 54 includes an image integrator and an object detector. The image integrator receives each of the video frames 22 and calculates a respective integral image representation of the video frame. The object detector includes a classifier, which implements a classification function, and an image scanner. The image scanner scans each of the video frames in same sized subwindows. The object detector uses a cascade of homogenous classifiers to classify the subwindows as to whether each subwindow is likely to contain an instance of a human face. Each classifier evaluates one or more predetermined features of a human face to determine the presence of such features in a subwindow that would indicate the likelihood of an instance of the human face in the subwindow.

In other embodiments, the face detection module 54 is implemented in accordance with the face detection approach that is described in U.S. Pat. No. 5,642,431. In these embodiments, the face detection module 54 includes a pattern prototype synthesizer and an image classifier. The pattern prototype synthesizer synthesizes face and non-face pattern prototypes are synthesized by a network training process using a number of example images. The image classifier detects images in the video frames 22 based on a computed distance between regions of the video frames 22 to each of the face and non-face prototypes.

In response to the detection of a human face in one of the video frames, the frame detection module 52 determines a facial bounding box encompassing the eyes, nose, mouth but not the entire forehead or chin or top of head of the detected face. The face detection module 54 outputs the following metadata for each of the video frames 22: the number of faces, the locations (e.g., the coordinates of the upper left and lower right corners) of the facial bounding boxes, and the sizes of the facial bounding boxes.

### c. Determining Image Quality Scores

FIG. 6 shows an embodiment of a method of determining a respective image quality score 60 for each of the video frames 22. In the illustrated embodiment, the image quality scoring module 56 processes the video frames 22 sequentially.

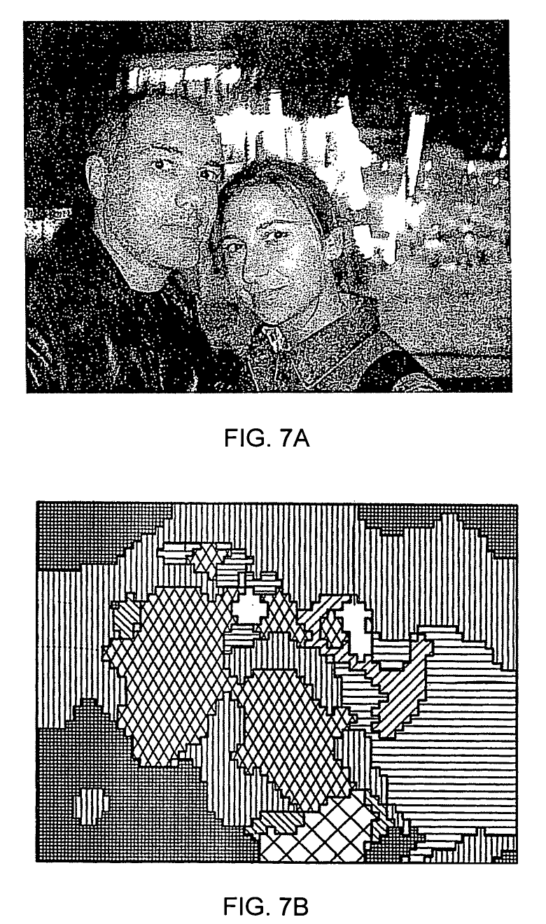

In accordance with this method, the image quality scoring module 56 segments the current video frame into sections (FIG. 6, block 64). In general, the image quality scoring module 56 may segment each of the video frames 22 in accordance with any of a wide variety of different methods for decomposing an image into different objects and regions. FIG. 7B shows an exemplary segmentation of the video frame of FIG. 7A into sections.

The image quality scoring module 56 determines a respective focal adjustment factor for each section (FIG. 6, block 66). In general, the image quality scoring module 56 may determine the focal adjustment factors in a variety of different ways. In one exemplary embodiment, the focal adjustment factors are derived from estimates of local sharpness that correspond to an average ratio between the high-pass and low-pass energy of the one-dimensional intensity gradient in local regions (or blocks) of the video frames 22. In accordance with this embodiment, each video frame 22 is divided into blocks of, for example, 100×100 pixels. The intensity gradient is computed for each horizontal pixel line and vertical pixel column within each block. For each horizontal and vertical pixel direction in which the gradient exceeds a gradient threshold, the image quality scoring module 56 computes a respective measure of local sharpness from the ratio of the high-pass energy and the low-pass energy of the gradient. A sharpness value is computed for each block by averaging the sharpness values of all the lines and columns within the block. The blocks with values in a specified percentile (e.g., the thirtieth percentile) of the distribution of the sharpness values are assigned to an out-of-focus map, and the remaining blocks (e.g., the upper seventieth percentile) are assigned to an in-focus map.

In some embodiments, a respective out-of-focus map and a respective in-focus map are determined for each video frame at a high (e.g., the original) resolution and at a low (i.e., downsampled) resolution. The sharpness values in the high-resolution and low-resolution out-of-focus and in-focus maps are scaled by respective scaling functions. The corresponding scaled values in the high-resolution and low-resolution out-of-focus maps are multiplied together to produce composite out-of-focus sharpness measures, which are accumulated for each section of the video frame. Similarly, the corresponding scaled values in the high-resolution and low-resolution in-focus maps are multiplied together to produce composite in-focus sharpness measures, which are accumulated for each section of the video frame. In some implementations, the image quality scoring module 56 scales the accumulated composite in-focus sharpness values of the sections of each video frame that contains a detected face by multiplying the accumulated composite in-focus sharpness values by a factor greater than one. These implementations increase the quality scores of sections of the current video frame containing faces by compensating for the low in-focus measures that are typical of facial regions.

For each section, the accumulated composite out-of-focus sharpness values are subtracted from the corresponding scaled accumulated composite in-focus sharpness values. The image quality scoring module 56 squares the resulting difference and averages the product by the number of pixels in the corresponding section to produce a respective focus adjustment factor for each section. The sign of the focus adjustment factor is positive if the accumulated composite out-of-focus sharpness value exceeds the corresponding scaled accumulated composite in-focus sharpness value; otherwise the sign of the focus adjustment factor is negative.

The image quality scoring module 56 determines a poor exposure adjustment factor for each section (FIG. 6, block 68). In this process, the image quality scoring module 56 identifies over-exposed and under-exposed pixels in each video frame 22 to produce a respective over-exposure map and a respective under-exposure map. In general, the image quality scoring module 56 may determine whether a pixel is over-exposed or under-exposed in a variety of different ways. In one exemplary embodiment, the image quality scoring module 56 labels a pixel as over-exposed if (i) the luminance values of more than half the pixels within a window centered about the pixel exceed 249 or (ii) the ratio of the energy of the luminance gradient and the luminance variance exceeds 900 within the window and the mean luminance within the window exceeds 239. On the other hand, the image quality scoring module 56 labels a pixel as under-exposed if (i) the luminance values of more than half the pixels within the window are below 6 or (ii) the ratio of the energy of the luminance gradient and the luminance variance within the window is exceeds 900 and the mean luminance within the window is below 30. The image quality scoring module 56 calculates a respective over-exposure measure for each section by subtracting the average number of over-exposed pixels within the section from 1. Similarly, the image quality scoring module 56 calculates a respective under-exposure measure for each section by subtracting the average number of under-exposed pixels within the section from 1. The resulting over-exposure measure and under-exposure measure are multiplied together to produce a respective poor exposure adjustment factor for each section.

The image quality scoring module 56 computes a local contrast adjustment factor for each section (FIG. 6, block 70). In general, the image quality scoring module 56 may use any of a wide variety of different methods to compute the local contrast adjustment factors. In some embodiments, the image quality scoring module 56 computes the local contrast adjustment factors in accordance with the image contrast determination method that is described in U.S. Pat. No. 5,642,433. In some embodiments, the local contrast adjustment factor Γ_{local}_{_{—}}_{contrast} is given by equation (1):

$${Γ}_{local\_contrast} = \begin{matrix} 1 & if {L}_{σ} > 100 \\ 1 + {L}_{σ} / 100 & f {L}_{σ} \leq 100\end{matrix} \qquad ( 1 )$$

where L_{σ} is the respective variance of the luminance of a given section.

For each section, the image quality scoring module 56 computes a respective quality measure from the focal adjustment factor, the poor exposure adjustment factor, and the local contrast adjustment factor (FIG. 6, block 72). In this process, the image quality scoring module 56 determines the respective quality measure by computing the product of corresponding focal adjustment factor, poor exposure adjustment factor, and local contrast adjustment factor, and scaling the resulting product to a specified dynamic range (e.g., 0 to 255). The resulting scaled value corresponds to a respective image quality measure for the corresponding section of the current video frame.

The image quality scoring module 56 then determines an image quality score for the current video frame from the quality measures of the constituent sections (FIG. 6, block 74). In this process, the image quality measures for the constituent sections are summed on a pixel-by-pixel basis. That is, the respective image quality measures of the sections are multiplied by the respective numbers of pixels in the sections, and the resulting products are added together. The resulting sum is scaled by factors for global contrast and global colorfulness and the scaled result is divided by the number of pixels in the current video frame to produce the image quality score for the current video frame. In some embodiments, the global contrast correction factor Γ_{global}_{_{—}}_{contrast} is given by equation (2):

$${Γ}_{global\_contrast} = 1 + \sqrt{\frac{{L}_{σ}}{1500}} \qquad ( 2 )$$

where L_{σ} is the variance of the luminance for the video frame in the CIE-Lab color space. In some embodiments, the global colorfulness correction factor Γ_{global}_{_{—}}_{color} is given by equation (3):

$${Γ}_{global\_color} = 0.6 + 0.5 \cdot \sqrt{\frac{{a}_{σ} + {b}_{σ}}{500}} \qquad ( 3 )$$

where a_{σ} and b_{σ} are the variances of the red-green axis (a), and a yellow-blue axis (b) for the video frame in the CIE-Lab color space.

The image quality scoring module 56 determines the facial region quality scores 62 by applying the image quality scoring process described above to the regions of the video frames corresponding to the bounding boxes that are determined by the face detection module 54.

Additional details regarding the computation of the image quality scores and the facial region quality scores can be obtained from copending U.S. patent application Ser. No. 11/127,278, which was filed May 12, 2005, by Pere Obrador, is entitled “Method and System for Image Quality Calculation,” and is incorporated herein by reference.

### 3. Exemplary Embodiments of the Frame Score Calculation Module

The frame score calculation module 44 calculates a respective frame score 28 for each frame 22 based on the frame characterizing parameter values 46 that are received from the frame characterization module 40. In some embodiments, the frame score calculation module 44 determines face scores based on the facial region quality scores 62 received from the image quality scoring module 56 and on the appearance of detectable faces in the frames 22. The frame score calculation module 44 computes the frame scores 28 based on the image quality scores 60 and the determined face scores. In some implementations, the frame score calculation module 44 confirms the detection of faces within each given frame based on an averaging of the number of faces detected by the face detection module 54 in a sliding window that contains the given frame and a specified number (e.g., twenty-nine) frames neighboring the given frame.

In some implementations, the value of the face score for a given video frame depends on the size of the facial bounding box that is received from the face detection module 54 and the facial region quality score 62 that is received from the image quality scoring module 56. The frame score calculation module 44 classifies the detected facial area as a close-up face if the facial area is at least 10% of the total frame area, as a medium sized face if the facial area is at least 3% of total frame area, and a small face if the facial area is in the range of 1-3% of the total frame area. In one exemplary embodiment, the face size component of the face score is 45% of the image quality score of the corresponding frame for a close-up face, 30% for a medium sized face, and 15% for a small face.

In some embodiments, the frame score calculation module 44 calculates a respective frame score Sₙ for each frame n in accordance with equation (4):

Sₙ=Qₙ+FSₙ (4)

where Qₙ is the image quality score of frame n and FSₙ is the face score for frame n, which is given by:

$${FS}_{n} = \frac{\sqrt{{Area}_{face}}}{c} + \frac{{Q}_{face , n}}{d} \qquad ( 5 )$$

where Area_{face} is the area of the facial bounding box, Q_{face,n} is the facial region quality score 62 for frame n, and c and d are parameters that can be adjusted to change the contribution of detected faces to the frame scores.

In some embodiments, the output video generation module 20 assigns to each given frame a weighted frame score S_{wn} that corresponds to a weighted average of the frame scores Sₙ for frames in a sliding window that contains the given frame and a specified number (e.g., nineteen) frames neighboring the given frame. The weighted frame score S_{wn} is given by equation (6):

$${S}_{wn} = [ {S}_{n} + {\sum }_{i = 1}^{m} ( ( {S}_{n + i} + {S}_{n - i} ) \times \frac{10 - i}{10} ) ] / ( 2 m + 1 ) \qquad ( 6 )$$

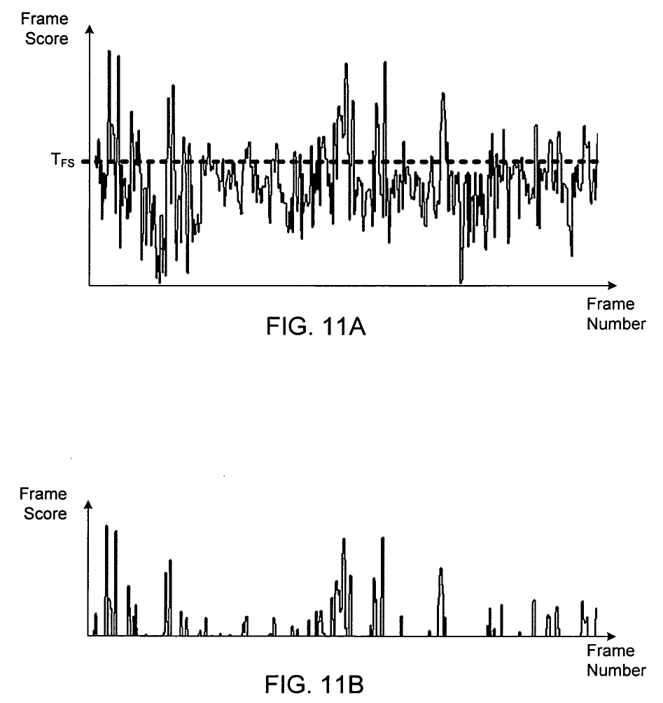

FIG. 11A shows an exemplary graph of the weighted frame scores that were determined for an exemplary set of video frames 22 from one of the input videos 12 in accordance with equation (12) and plotted as a function of frame number.

### B. Exemplary Embodiments of the Motion Estimation Module

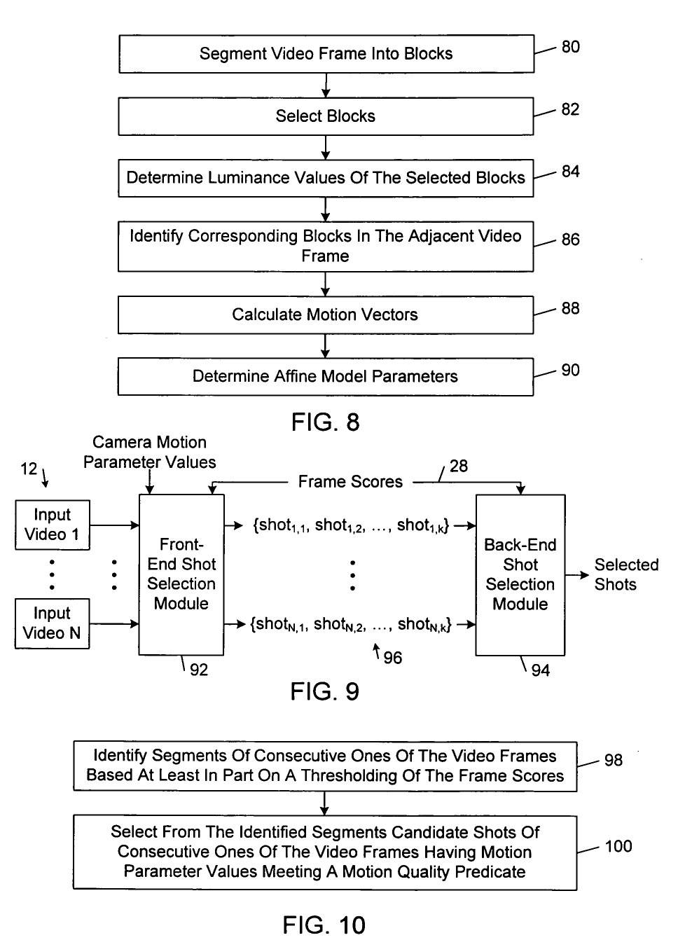

FIG. 8 shows an embodiment of a method in accordance with which the motion estimation module 17 determines the camera motion parameter values 48 for each of the video frames 22 of the input videos 12. In accordance with this method, the motion estimation module 17 segments each of the video frames 22 into blocks (FIG. 8, block 80).

The motion estimation module 17 selects one or more of the blocks of a current one of the video frames 22 for further processing (FIG. 8, block 82). In some embodiments, the motion estimation module 17 selects all of the blocks of the current video frame. In other embodiments, the motion estimation module 17 tracks one or more target objects that appear in the current video frame by selecting the blocks that correspond to the target objects. In these embodiments, the motion estimation module 17 selects the blocks that correspond to a target object by detecting the blocks that contain one or more edges of the target object.

The motion estimation module 17 determines luminance values of the selected blocks (FIG. 8, block 84). The motion estimation module 17 identifies blocks in an adjacent one of the video frames 22 that correspond to the selected blocks in the current video frame (FIG. 8, block 86).

The motion estimation module 17 calculates motion vectors between the corresponding blocks of the current and adjacent video frames (FIG. 8, block 88). In general, the motion estimation module 17 may compute the motion vectors based on any type of motion model. In one embodiment, the motion vectors are computed based on an affine motion model that describes motions that typically appear in image sequences, including translation, rotation, and zoom. The affine motion model is parameterized by six parameters as follows:

$$U = ( \begin{matrix}u \\ v\end{matrix} ) = ( \begin{matrix}{a}_{x 0} & {a}_{x 1} & {a}_{x 2} \\ {a}_{y 0} & {a}_{y 1} & {a}_{y 2}\end{matrix} ) \cdot ( \begin{matrix}x \\ y \\ z\end{matrix} ) = A \cdot ( \begin{matrix}x \\ y \\ z\end{matrix} ) \qquad ( 7 )$$

where u and v are the x-axis and y-axis components of a velocity motion vector at point (x,y,z), respectively, and the aₖ's are the affine motion parameters. Because there is no depth mapping information for a non-stereoscopic video signal, z=1. The current video frame Iᵣ(P) corresponds to the adjacent video frame Iₜ(P) in accordance with equation (8):

Iᵣ(P)=Iₜ(P−U(P)) (8)

where P=P(x, y) represents pixel coordinates in the coordinate system of the current video frame.

The motion estimation module 17 determines the camera motion parameter values 48 from an estimated affine model of the camera's motion between the current and adjacent video frames (FIG. 8, block 90). In some embodiments, the affine model is estimated by applying a least squared error (LSE) regression to the following matrix expression:

A=(X^{T}X)⁻¹X^{T}U (9)

where X is given by:

$$X = ( \begin{matrix}{x}_{1} & {x}_{2} & ⋯ & {x}_{N} \\ {y}_{1} & {y}_{2} & ⋯ & {y}_{N} \\ 1 & 1 & ⋯ & 1\end{matrix} ) \qquad ( 10 )$$

and U is given by:

$$U = ( \begin{matrix}{u}_{1} & {u}_{2} & ⋯ & {u}_{N} \\ {v}_{1} & {v}_{2} & ⋯ & {v}_{N}\end{matrix} ) \qquad ( 11 )$$

where N is the number of samples (i.e., the selected object blocks). Each sample includes an observation (xᵢ, yᵢ, 1) and an output (u_{i,} vᵢ) that are the coordinate values in the current and previous video frames associated by the corresponding motion vector. Singular value decomposition may be employed to evaluate equation (9) and thereby determine A. In this process, the motion estimation module 17 iteratively computes equation (9). Iteration of the affine model typically is terminated after a specified number of iterations or when the affine parameter set becomes stable to a desired extent. To avoid possible divergence, a maximum number of iterations may be set.

The motion estimation module 17 typically is configured to exclude blocks with residual errors that are greater than a threshold. The threshold typically is a predefined function of the standard deviation of the residual error R, which is given by:

$$R ( m , n ) = E ( {P}_{k} , A \cdot {\tilde{P}}_{k - 1} ) \vert \begin{matrix}{P}_{k} ∈ {B}_{k} ( m , n ) \\ {P}_{k - 1} ∈ {B}_{k - 1} ( m + {v}_{x} , n + {v}_{y} )\end{matrix} \qquad ( 12 )$$

where Pₖ, \tilde{P}ₖ₋₁ are the blocks associated by the motion vector (vₓ, v_{y}). Even with a fixed threshold, new outliers may be identified in each of the iterations and excluded.

Additional details regarding the determination of the camera motion parameter values 48 can be obtained from copending U.S. patent application Ser. No. 10/972,003, which was filed Oct. 25, 2004 by Tong Zhang et al., is entitled “Video Content Understanding Through Real Time Video Motion Analysis,” and is incorporated herein by reference. * * *

### C. Exemplary Embodiments of the Shot Selection Module

### 1. Overview

As explained above, the shot selection module 18 selects a respective set of shots of consecutive ones of the video frames 22 from each of the input videos 12 based on the frame characterizing parameter values 46 that are received from the frame characterization module 40 and the camera motion parameter values 48 that are received from the motion estimation module 17. The shot selection module 18 passes the selected shots 32 to the output video generation module 20, which integrates content from the selected shots 32 into the output video 14.

FIG. 9 shows an exemplary embodiment of the shot selection module 18 that includes a front-end shot selection module 92 and a back-end shot selection module 94. The front-end shot selection module 92 selects a respective set of candidate shots 96 from each of the input videos 12. The back-end shot selection module 94 selects the final set of selected shots 32 from the candidate shots 96 based on the frame scores 28, user preferences, and filmmaking rules.

### 2. Exemplary Embodiments of the Front-End Shot Selection Module

### a. Overview

FIG. 10 shows an embodiment of a method in accordance with which the front-end shot selection module 92 identifies the candidate shots 96.

The front-end shot selection module 92 identifies segments of consecutive ones of the video frames 22 based at least in part on a thresholding of the frame scores 28 (FIG.10, block 98). The thresholding of the frame scores 28 segments the video frames 22 into an accepted class of video frames that are candidates for inclusion into the output video 14 and a rejected class of video frames that are not candidates for inclusion into the output video 14. In some implementations, the front-end shot selection module 92 may reclassify ones of the video frames from the accepted class into the rejected class and vice versus depending on factors other than the assigned frame scores, such as continuity or consistency considerations, shot length requirements, and other filmmaking principles.

The front-end shot selection module 92 selects from the identified segments candidate shots of consecutive ones of the video frames 22 having motion parameter values meeting a motion quality predicate (FIG. 10, block 100). In addition, the front-end shot selection module 92 typically selects the candidate shots from the identified segments based on user-specified preferences and filmmaking rules. For example, the front-end shot selection module 92 may determine the in-points and out-points for ones of the identified segments based on rules specifying one or more of the following: a maximum length of the output video 14; maximum shot lengths as a function of shot type; and in-point and out-point locations in relation to detected faces and object motion.

### b. Threshholding Frame Scores

As explained above, the front-end shot selection module 92 identifies segments of consecutive ones of the video frames 22 based at least in part on a thresholding of the frame scores 28 (see FIG. 10, block 98). In general, the threshold may be a threshold that is determined empirically or it may be a threshold that is determined based on characteristics of the video frames (e.g., the computed frame scores) or preferred characteristics of the output video 14 (e.g., the length of the output video).

In some embodiments, the frame score threshold (T_{FS}) is given by equation (13):

T_{FS}=T_{FS,AVE}+θ·(S_{wm,MAX}−S_{wm,MIN}) (13)

where T_{FS,AVE} is the average of the weighted frame scores for the video frames 22, S_{wn,MAX} is the maximum weighted frame score, S_{wn,MIN} is the minimum weighted frame score, and θ is a parameter that has a values in the range of 0 to 1. The value of the parameter θ determines the proportion of the frame scores that meet the threshold and therefore is correlated with the length of the output video 14.

In FIG. 11A an exemplary frame score threshold (T_{FS}) is superimposed on the exemplary graph of frame scores that were determined for an exemplary set of input video frames 22 in accordance with equation (13). FIG. 11B shows the frame scores of the video frames in the graph shown in FIG. 11A that exceed the frame score threshold T_{FS}.

Based on the frame score threshold, the front-end shot selection module 92 segments the video frames 22 into an accepted class of video frames that are candidates for inclusion into the output video 14 and a rejected class of video frames that are not candidates for inclusion into the output video 14. In some embodiments, the front-end shot selection module 92 labels with a “1” each of the video frames 22 that has a weighted frame score that meets the frame score threshold T_{FS} and labels with a “0” the remaining ones of the video frames 22. The groups of consecutive video frames that are labeled with a “1” correspond to the identified segments from which the front-end shot selection module 92 selects the candidate shots 96 that are passed to the back-end shot selection module 94.

In addition to excluding from the accepted class video frames that fail to meet the frame score threshold, some embodiments of the front-end shot selection module 92 exclude one or more of the following types of video frames from the accepted class:
ones of the video frames having respective focus characteristics that fail to meet a specified image focus predicate (e.g., at least 10% of the frame must be in focus to be included in the accepted class);
ones of the video frames having respective exposure characteristics that fail to meet a specified image exposure predicate (e.g., at least 10% of the frame must have acceptable exposure levels to be included in the accepted class);
ones of the video frames having respective color saturation characteristics that fail to meet a specified image saturation predicate (e.g., the frame must have at least medium saturation and facial areas must be in a specified “normal” face saturation range to be included in the accepted class);
ones of the video frames having respective contrast characteristics that fail to meet a specified image contrast predicate (e.g., the frame must have at least medium contrast to be included in the accepted class); and
ones of the video frames having detected faces with compositional characteristics that fail to meet a specified headroom predicate (e.g., when a face is detected in the foreground or mid-ground of a shot, the portion of the face between the forehead and the chin must be completely within the frame to be included in the accepted class).

In some implementations, the front-end shot selection module 92 reclassifies ones of the video frames 22 from the accepted class into the rejected class and vice versus depending on factors other than the assigned image quality scores, such as continuity or consistency considerations, shot length requirements, and other filmmaking principles. For example, in some embodiments, the front-end shot selection module 92 applies a morphological filter (e.g., a one-dimensional closing filter) to incorporate within respective ones of the identified segments ones of the video frames neighboring the video frames labeled with a “1” and having respective image quality scores insufficient to satisfy the image quality threshold. The morphological filter closes isolated gaps in the frame score level across the identified segments and thereby prevents the loss of possibly desirable video content that otherwise might occur as a result of aberrant video frames. For example, if there are twenty video frames with respective frame scores over 150, followed by one video frame with a frame score of 10, followed by ten video frames with respective frame scores over 150, the morphological filter reclassifies the aberrant video frame with the low frame score to produce a segment with thirty-one consecutive video frames in the accepted class.

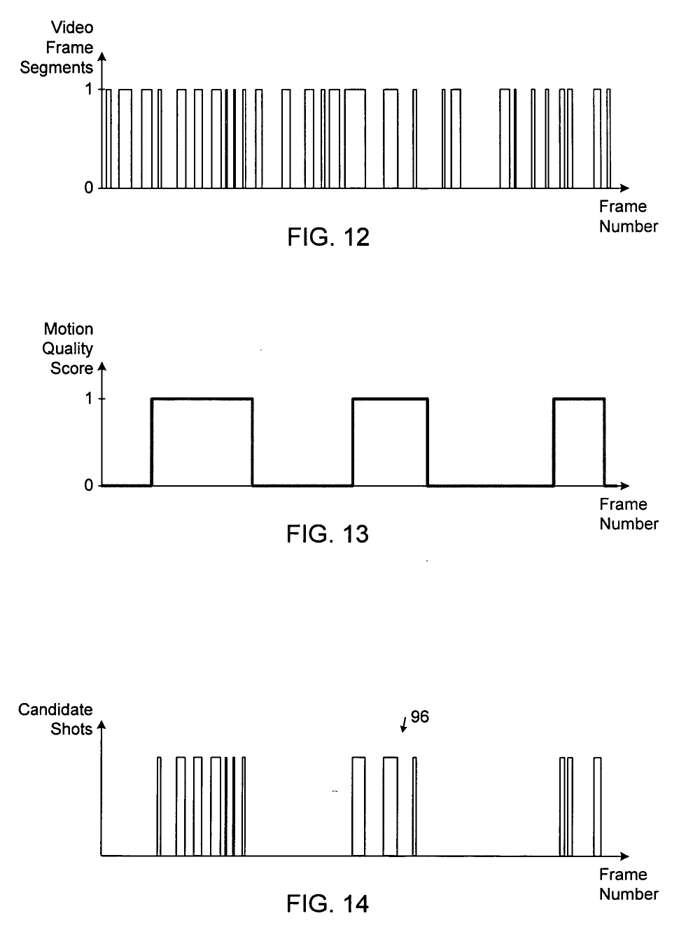

FIG. 12 shows a devised set of segments of consecutive video frames that are identified based at least in part on the thresholding of the image quality scores shown in FIGS. 11A and 11B.

### c. Selelcting Candidate Shots

As explained above, the front-end shot selection module 92 selects from the identified segments candidate shots 96 of consecutive ones of the video frames 22 having motion parameter values meeting a motion quality predicate (see FIG. 10, block 100). The motion quality predicate defines or specifies the accepted class of video frames that are candidates for inclusion into the output video 14 in terms of the camera motion parameters 48 that are received from the motion estimation module 17. In one exemplary embodiment, the motion quality predicate M_{accepted} for the accepted motion class is given by:

M_{accepted}={pan rate≦Ωₚ and zoom rate≦Ω_{z}} (14)

where Ωₚ is an empirically determined threshold for the pan rate camera motion parameter value and Ω_{z} is an empirically determined threshold for the zoom rate camera motion parameter value. In one exemplary embodiment, Ωₚ=1 and Ω_{z}=1.

In some implementations, the front-end shot selection module 92 labels each of the video frames 22 that meets the motion class predicate with a “1” and labels the remaining ones of the video frames 22 with a “0”. FIG. 13 shows a devised graph of motion quality scores indicating whether or not the motion quality parameters of the corresponding video frame meet a motion quality predicate.

The front-end shot selection module 92 selects the ones of the identified video frame segments shown in FIG. 12 that contain video frames with motion parameter values that meet the motion quality predicate as the candidate shots 96 that are passed to the back-end shot selection module 94. FIG. 14 is a devised graph of candidate shots 96 of consecutive video frames selected from the identified segments shown in FIG. 12 and meeting the motion quality predicate as shown in FIG. 13.

In some embodiments, the front-end shot selection module 92 also selects the candidate shots 96 from the identified segments shown in FIG. 12 based on user-specified preferences and filmmaking rules. For example, in some implementations, the front-end shot selection module 92 divides each of the input videos 12 temporally into a series of consecutive clusters of the video frames 22. In some embodiments, the front-end shot selection module 92 clusters the video frames 22 based on timestamp differences between successive video frames. For example, in one exemplary embodiment a new cluster is started each time the timestamp difference exceeds one minute. For an input video 12 that does not contain any timestamp breaks, the front-end shot selection module 92 may segment the video frames 22 into a specified number (e.g., five) of equal-length segments. The front-end shot selection module 92 then ensures that each of the clusters is represented at least one by the set of selected shots unless the cluster has nothing acceptable in terms of focus, motion and image quality. When one or more of the clusters is not represented by the initial round of candidate shot selection, the front-end shot selection module 92 may re-apply the candidate shot selection process for each of the unrepresented clusters with one or more of the thresholds lowered from their initial values.

In some implementations, the front-end shot selection module 92 may determine the in-points and out-points for ones of the identified segments based on rules specifying one or more of the following: a maximum length of the output video 14; maximum shot lengths as a function of shot type; and in-point and out-point locations in relation to detected faces and object motion. In some of these implementations, the front-end shot selection module 92 selects the candidate shots from the identified segments in accordance with one or more of the following filmmaking rules:
No shot will be less than 20 frames long or greater than 2 minutes. At least 50% of the selected shots must be 10 seconds or less, and it is acceptable if all the shots are less than 10 seconds.
If a segment longer than 3 seconds has a consistent, unchanging image with no detectable object or camera motion, select a 2 second segment that begins 1 second after the start of the segment.
Close-up shots will last no longer than 30 seconds.
Wide Shots and Landscape Shots will last no longer than 2 minutes.
For the most significant (largest) person in a video frame, insert an in-point on the first frame that person's face enters the “face zone” and an out-point on the first frame after his or her face leaves the face zone. In some implementations, the face zone is the zone defined by vertical and horizontal lines located one third of the distance from the edges of the video frame.
When a face is in the foreground and mid-ground of a shot, the portion of the face between the forehead and the chin should be completely within the frame.
All shots without any faces detected for more than 5 seconds and containing some portions of sky will be considered landscape shots if at least 30% of the frame is in-focus, is well-exposed, and there is medium-to-high image contrast and color saturation.

In some embodiments, the front-end shot selection module 92 ensures that an out-point is created in a given one of the selected shots containing an image of an object from a first perspective in association with a designated motion type only when a successive one of the selected shots contains an image of the object from a second perspective different from the first perspective in association with the designated motion type. Thus, an out-point may be made in the middle of an object (person) motion (examples: someone standing up, someone turning, someone jumping) only if the next shot in the sequence is the same object, doing the same motion from a different camera angle. In these embodiments, the front-end shot selection module 92 may determine the motion type of the objects contained in the video frames 22 in accordance with the object motion detection and tracking process described in copending U.S. patent application Ser. No. 10/972,003, which was filed Oct. 25, 2004 by Tong Zhang et al., is entitled “Video Content Understanding Through Real Time Video Motion Analysis.” In accordance with this approach, the front-end shot selection module 92 determines that objects have the same motion type when their associated motion parameters are quantized into the same quantization level or class.

### 3. Exemplary Embodiments of the Back-End Shot Selection Module

The back-end shot selection module 94 selects the final set of selected shots 32 from the candidate shots 96 based on the frame scores 28, user preferences, and filmmaking rules.

In this process, the back-end shot selection module 94 synchronizes the candidate shots 96 in accordance with temporal metadata that is associated with each of the input videos 12. The temporal metadata typically is in the form of timestamp information that encodes the respective capture times of the video frames 22. In some implementations, the temporal metadata encodes the coordinated universal times (UTC) when the video frames were captured. The temporal metadata may be stored in headers of the input videos 12 or in a separate data structure, or both.

After the candidate shots 96 have been synchronized, the back-end shot selection module 94 ascertains sets of coincident sections of respective ones of the candidate shots 96 from different ones of the input videos 12 that have coincident temporal metadata.

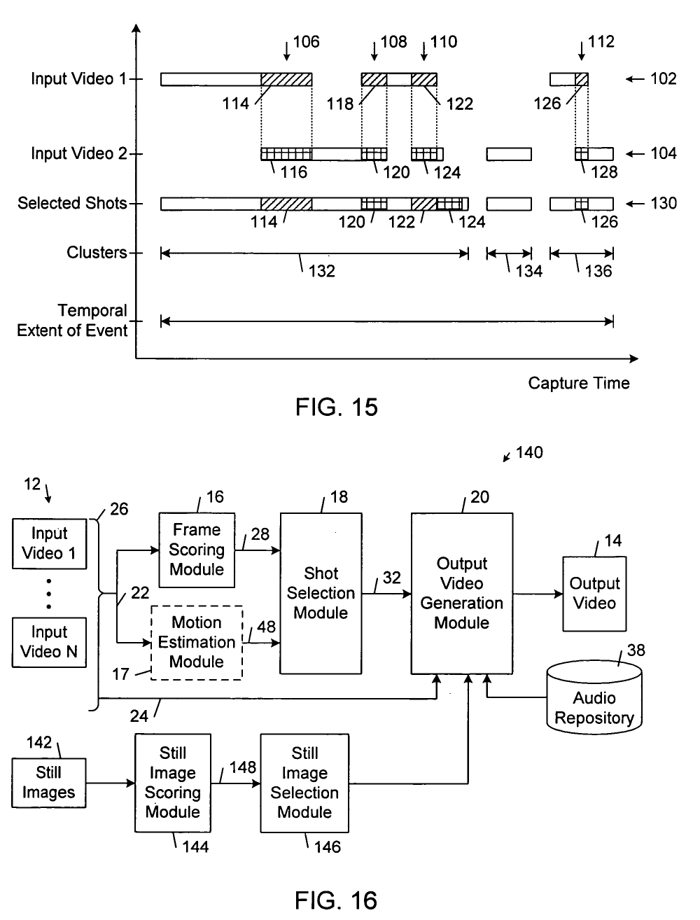

FIG. 15 shows two exemplary sets 102, 104 of candidate shots that were selected from two input videos (i.e., Input Video 1 and Input Video 2) and plotted as a function of temporal metadata corresponding to the capture times of the video frames. The sets 102, 104 of candidate shots are synchronized in accordance with their respective capture times. In this example, there are four sets 106, 108, 110,112 of coincident sections of the input videos that have coincident temporal metadata. The first coincident set 106 consists of the frame section 114 from Input Video 1 and the frame section 116 from Input Video 2. The second coincident set 108 consists of the frame section 118 from Input Video 1 and the frame section 120 from Input Video 2. The third coincident set 110 consists of the frame section 122 from Input Video 1 and the frame section 124 from Input Video 2. The fourth coincident set 112 consists of the frame section 126 from Input Video 1 and the frame section 128 from Input Video 2.

The back-end shot selection module 94 selects from each of the ascertained sets of coincident sections a respective shot corresponding to the coincident section highest in frame score. For illustrative purposes, assume that the frame score associated with section 114 is higher than the frame score associated with section 116, the frame score associated with section 120 is higher than the frame score associated with section 118, the frame score associated with section 122 is higher than the frame score associated with section 124, and the frame score associated with section 128 is higher than the frame score associated with section 126. In this case, the back-end shot selection module 94 would select the sections 114, 120, 122, and 128 as ones of the selected shots 32.

In some embodiments, the back-end shot selection module 94 identifies in each of the ascertained sets of coincident sections ones of the coincident sections containing image content from different scenes, and selects each of the identified sections as a respective shot. In this process, the back-end shot selection module 94 may use spatial metadata (e.g., GPS metadata) that is associated with the video frames 12 to determine when coincident sections correspond to the same event. The back-end shot selection module 94 may use one or more image content analysis processes (e.g., color histogram, color layout difference, edge detection, and moving object detection) to determine when coincident sections contain image content from the same scene or from different scenes.

In these embodiments, the back-end shot selection module 94 is permitted to select as shots coincident sections of different input videos that contain image content from different scenes of the same event (e.g., the audience and the performance they are watching). In the example shown in FIG. 15, assume that the coincident sections 122 and 124 contain image content from different scenes. In this case, the back-end shot selection module 94 would select both sections 122, 124 as ones of the selected shots 32.

As shown in FIG. 15, the final set 130 of shots that are selected by the back-end shot selection module 94 consists of the non-coincident sections of the input videos, the ones of the sections in each coincident set that are highest in frame score, and, in some embodiments, the ones of the sections in each coincident set that contain image content from different scenes. For illustrative purposes, it is assumed that the coincident sections 122, 124 contain image content from different scenes. For this reason, both of the coincident sections 122 and 124 are included in the final set 130 of selected shots.

### D. Exemplary Embodiments of the Output Video Generation Module

As explained above, the output video generation module 20 generates the output video 14 from the selected shots (see FIG. 2, block 36). The selected shots typically are arranged in chronological order with one or more transitions (e.g., fade out, fade in, and dissolves) that connect adjacent ones of the selected shots in the output video 14. The output video generation module 20 may incorporate an audio track into the output video 14. The audio track may contain selections from one or more audio sources, including the audio data 24 and music and other audio content selected from an audio repository 38 (see FIG. 1).

In some implementations, the output video generation module 20 generates the output video 14 from the selected shots in accordance with one or more of the following filmmaking rules:
The total duration of the output video 14 is scalable. The user could generate multiple summaries of the input video data 12 that have lengths between 1 and 99% of the total footage. In some embodiments, the output video generation module is configured to generate the output video 14 with a length that is approximately 5% of the length of the input video data 12.
In some embodiments, the output video generation module 20 inserts the shot transitions in accordance with the following rules: insert dissolves between shots at different locations; insert straight cuts between shots in the same location; insert a fade from black at the beginning of each sequence; and insert a fade out to black at the end of the sequence.
In some implementations, the output video generation module inserts cuts in accordance with the rhythm of an accompanying music track.

In some embodiments, the overall length of the output video 14 is constrained to be within a specified limit. The limit may be specified by a user or it may be a default limit. For example, in some implementations, the default length of the output video 14 is constrained to be coextensive with the collective extent of the temporal metadata that is associated with the media content that is integrated into the output video 14. In these implementations, the output video generation module 20 ensures that the output video 14 has a length that is at most coextensive with that collective extent. Thus, if for example, two cameras recorded an event, where the first camera recorded one hour of the event, the second camera recorded two hours of the event with half an hour overlapping with the footage recorded by the first camera, the output video generation module 20 would ensure that the output video 14 has a length that is at most coextensive with the collective extent of two and a half hours.

In some of these embodiments, the output video generation module 20 temporally divides the selected shots 32 into a series of clusters, and chooses at least one shot from each of the clusters. The selected shots 32 may be divided into contemporaneous groups based on the temporal metadata that is associated with the constituent video frames. In some implementations, the output video generation module 20 preferentially selects one of the sections of the input videos that is associated with temporal metadata that coincides with the temporal metadata associated with a respective section of another one of the input videos.

In the example shown in FIG. 15, the output video generation module 20 temporally divides the selected shots into clusters 132, 134, 136. If length constraints prevent the output video generation module 20 from selecting all of the selected shots 32, the output video generation module 20 selects at least one shot from each of the clusters 132, 134, 136 and preferentially selects the ones of selected shots that are coincident with sections of other ones of the input videos (i.e., sections 114, 120, 122, 124, 126).

After selecting the final shots that will be integrated into the output video 14, the output video generation module 20 crops the video frames 12 of the selected shots to a common aspect ratio. In some embodiments, the output video generation module 20 selects the aspect ratio that is used by at least 60% of the selected shots. If no aspect ratio covers the 60% majority of the selected shots, then the output video generation module 20 will select the widest of the aspect ratios that appear in the selected shots. For example, if some of the footage has an aspect ratio of 16×9 and other footage has an aspect ratio of 4×3, the output video generation module 20 will select the 16×9 aspect ratio to use for cropping. In some embodiments, the output video generation module 20 crops the video frames 12 based on importance maps that identify regions of interest in the video frames. In some implementations, the importance maps are computed based on a saliency-based image attention model that is used to identify the regions of interest based on low-level features in the frames (e.g., color, intensity, and orientation).

### III. ADDITIONAL EXEMPLARY COMPONENTS OF THE VIDEO PRODUCTION SYSTEM

FIG. 16 shows an embodiment 140 of the video production system 10 that is capable of integrating still images 142 into the output video 14. In addition to the components of the video production system 10, the video production system 140 includes a still image scoring module 144 and a still image selection module 146.

The still image scoring module 144 assigns respective image quality scores 148 to the still images 142. In some implementations, the still image scoring module 144 corresponds to the frame characterization module 40 that is described above and shown in FIG. 5. In these implementations, the still image scoring module 144 may be implemented as a separate component as shown in FIG. 16. Alternatively, the still image scoring module 144 may be implemented by the frame characterization module 40 of the frame scoring module 16. In this case, the still images 142 are passed to the frame scoring module 16, which generates a respective image quality score 148 for each of the still images 142.

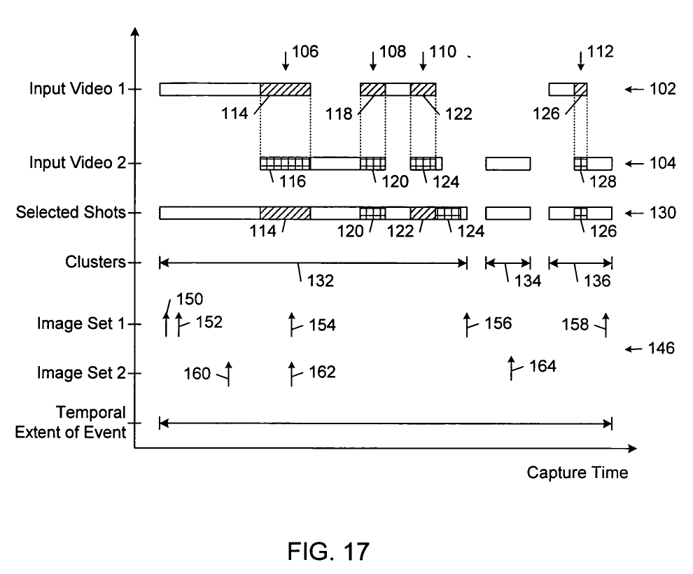

FIG. 17 shows the candidate and selected shots in the example shown in FIG. 15 along with two exemplary sets of still images 146 (i.e., Image Set 1 and Image Set 2) plotted as a function of capture time. Image Set 1 consists of still images 150, 152, 154, 156, and 158. Image Set 2 consists of still images 160, 162, 164. The still images 150, 152, 154, 160, 162 are associated with temporal metadata that falls within cluster 132, the still image 164 is associated with temporal metadata that falls within cluster 134, and the still image 158 is associated with temporal metadata that falls within cluster 136. The still images 154 and 162 are associated with coincident temporal metadata (i.e., their temporal metadata are essentially the same within a specified difference threshold).

The still image selection module 146 selects ones of the still images 142 as candidate still images based on the assigned image quality scores. In some embodiments, the still image selection module 146 chooses ones of the still images as candidate still images based at least in part on a thresholding of the image quality scores. The image quality score threshold may be set to obtain a specified number or a specified percentile of the still images highest in image quality score.

In some embodiments, the still image selection module 146 chooses ones of the sill images respectively associated with temporal metadata that is free of overlap with temporal metadata respectively associated with any of the selected shots, regardless of the image scores assigned to these still images. Thus, in the example shown in FIG. 17, the still image selection module 146 would select the still image 156 whether or not the image quality score assigned to the still image 156 met the image quality score threshold.

The output video generation module 20 generates the output video 14 from the selected shots and the selected still images. In general, the output video generation module 20 may covert the still images into video in any of a wide variety of different ways, including presenting ones of the selected still images as static images for a specified period (e.g., two seconds), and panning or zooming across respective regions of ones of the selected still images for a specified period.

The output video generation module 20 typically arranges the selected shots and the chosen still images in chronological order with one or more transitions (e.g., fade out, fade in, and dissolves) that connect adjacent ones of the selected shots and still images in the output video 14. In some embodiments, the output video generation module 20 identifies ones of the chosen still images that are respectively associated with temporal metadata that is coincident with the temporal metadata respectively associated with ones of the selected shots, and inserts the identified ones of the chosen still images into the output video 14 at locations adjacent to (i.e., before or after) the coincident ones of the selected shots

In some implementations, the output video generation module 20 temporally divides the selected shots into a series of consecutive clusters and inserts selected groups of the chosen still images at specific locations (e.g., beginning or ending) of the clusters. In some embodiments, the output video generation module 20 clusters the selected shots based on timestamp differences between successive video frames of different ones of the selected shots. In some of these embodiments, the output video generation module 20 clusters the selected shots using a k-nearest neighbor (KNN) clustering process.

After selecting the final shots and still images that will be integrated into the output video 14, the output video generation module 20 crops the video frames 12 of the selected shots and the selected still images to a common aspect ratio, as described above. In some embodiments, the output video generation module 20 crops the selected video frames and still images based on importance maps that identify regions of interest in the video frames and still images. In some implementations, the importance maps are computed based on a saliency-based image attention model that is used to identify the regions of interest based on low-level features in the frames (e.g., color, intensity, and orientation).

### IV. CONCLUSION

The embodiments that are described in detail herein are capable of automatically producing high quality edited video content from input video data. At least some of these embodiments process the input video data in accordance with filmmaking principles to automatically produce an output video that contains a high quality video summary of the input video data.

Other embodiments are within the scope of the claims.

What is claimed is:

1. A method of producing an output video, comprising:
assigning respective frame scores to video frames of input videos containing respective sequences of video frames;
selecting shots of consecutive video frames from the input videos based at least in part on the assigned frame scores; and
generating an output video from the selected shots.

2. The method of claim 1, wherein the selecting comprises:
identifying segments of consecutive video frames of the input videos based at least in part on a thresholding of the assigned frame scores; and
ascertaining sets of coincident sections of respective ones of the segments identified in different ones of the input videos that have coincident temporal metadata.

3. The method of claim 2, wherein the selecting comprises selecting from each of the ascertained sets a respective shot corresponding to the coincident section highest in frame score.

4. The method of claim 2, wherein the selecting comprises identifying ones of the coincident sections in each of the ascertained sets containing image content from different scenes, and selecting each of the identified sections as a respective shot.

5. The method of claim 1, wherein the selecting comprises temporally dividing the video frames of the input videos into a series of clusters, and choosing at least one shot from each of the clusters.

6. The method of claim 5, wherein the dividing comprises clustering the video frames into contemporaneous groups based on temporal metadata associated with the video frames.

7. The method of claim 5, wherein the choosing comprises selecting a shot corresponding to a section of one of the input videos that is associated with temporal metadata that coincides with temporal metadata associated with a respective section of another one of the input videos.

8. The method of claim 1, further comprising assigning respective image quality scores to still images and choosing ones of the still images based at least in part on the assigned image quality scores, wherein the generating comprises generating the output video from the selected shots and the chosen still images.

9. The method of claim 8, wherein the choosing comprises choosing ones of the still images based at least in part on a thresholding of the image quality scores.

10. The method of claim 8, wherein the choosing comprises choosing ones of the still images respectively associated with temporal metadata that is free of overlap with temporal metadata respectively associated with any of the selected shots.

11. The method of claim 8, wherein the generating comprises chronologically integrating the chosen still images with the selected shots in accordance with temporal metadata respectively associated with the chosen still images and the selected shots.

12. The method of claim 11, wherein the integrating comprises identifying ones of the chosen still images respectively associated with temporal metadata that is coincident with temporal metadata respectively associated with coincident ones of the selected shots, and inserting the identified ones of the chosen still images into the output video at locations adjacent to the coincident ones of the selected shots.

13. The method of claim 1, further comprising, before the assigning, color correcting the video frames of the input videos.

14. The method of claim 1, further comprising cropping the video frames of the selected shots to a common aspect ratio.

15. The method of claim 1, wherein the generating comprises integrating content from media sources including the input videos that are respectively associated with temporal metadata having a collective extent and ensuring that the output video has a length that is at most coextensive with that collective extent.

16. A system for producing an output video, comprising:
a frame scoring module operable to assign respective frame scores to video frames of input videos containing respective sequences of video frames;
a shot selection module operable to select shots of consecutive video frames from the input videos based at least in part on the assigned frame scores; and
an output video generation module operable to generate an output video from the selected shots.

17. The system of claim 16, wherein the shot selection module is operable to identify segments of consecutive video frames of the input videos based at least in part on a thresholding of the assigned frame scores, and ascertain sets of coincident sections of respective ones of the segments identified in different ones of the input videos that have coincident temporal metadata.

18. The system of claim 16, wherein the shot selection module is operable to temporally divide the video frames of the input videos into a series of clusters, and choosing at least one shot from each of the clusters.

19. The system of claim 16, further comprising an image scoring module operable to assign respective image quality scores to still images, and an image selection module operable to choose ones of the still images based at least in part on the assigned image quality scores, wherein the output video generation module is operable to generate the output video from the selected shots and the chosen still images.

20. A system for producing an output video, comprising:
means for assigning respective frame scores to video frames of input videos containing respective sequences of video frames;
means for selecting shots of consecutive video frames from the input videos based at least in part on the assigned frame scores; and
means for generating an output video from the selected shots.
